(19) United States
(12) Patent Application Publication
(10) Pub. No.: US 2009/0277520 A1
(43) Pub. Date: Nov. 12, 2009

(54) Faucet attachment device

(76) Inventor: Hsiang Hung Wang, Changhua (TW)

Correspondence Address: CHARLES E. BAXLEY, ESQUIRE, 90 JOHN STREET, SUITE 309, NEW YORK, NY, 10038, US

(21) Appl. No.: 12/151,410

(22) Filed: May 6, 2008

(51) Int. Cl. B67D 5/00

(52) U.S. Cl. 137/801

(57) ABSTRACT

A faucet attachment device includes a casing disposed in a housing and having one or more upper notches, a lock member attached to the housing for retaining the casing in the housing, a base member disposed in the housing and engaged with the casing and having one or more keys engaged with the notches of the casing for preventing the base member from being rotated relative to the casing, and a water control device is engaged with the base member for controlling the water to flow out through the spout of the housing. The chamber and the housing include a cylindrical structure having a uniform inner diameter and outer diameter for easily assembling the base member and the water control device.

### BACKGROUND OF THE INVENTION

1. Field of the Invention

The present invention relates to a faucet attachment device, and more particularly to a faucet attachment device including an improved structure for easily and readily attaching or securing the faucet to the basin, sink, or other mounting structure.

2. Description of the Prior Art

Typical faucet are provided for attaching to the basin, sink, or other mounting structure, and coupled to a water reservoir for receiving the water from the water reservoir, and comprise a valve or control device disposed within the faucet for controlling the water to selectively flow out through the faucet.

For example, U.S. Pat. No. 5,727,587 to Yang, and U.S. Pat. No. 6,029,687 to Chang disclose two of the typical mixing control valves provided for being disposed within the faucet and coupled to a cold water reservoir and a hot water reservoir for receiving the cold water and the hot water from the water reservoirs, and for controlling the mixing of the cold water and the hot water and for controlling the mixed water to selectively flow out through the faucet.

However, the specially designed mixing control valves may only be attached or secured into the specially designed faucet body and may not be easily and readily attached or secured into the other faucet bodies.

U.S. Pat. No. 6,161,581 to Yang discloses another typical mixing control valve including an outer housing for receiving the valve or control members.

However, the outer housing is also required to be specially designed for accommodating the valve or control members, and the outer housing may not be easily and readily attached or secured onto the basin, sink, or other mounting structure.

The present invention has arisen to mitigate and/or obviate the afore-described disadvantages of the conventional faucet attachment devices.

### SUMMARY OF THE INVENTION

The primary objective of the present invention is to provide a faucet attachment device including an improved structure for easily and readily attaching or securing the faucet to the basin, sink, or other mounting structure.

In accordance with one aspect of the invention, there is provided a faucet attachment device comprising a housing including a chamber formed therein, and including a lower portion and an upper portion, and including a spout extended out from the housing and communicating with the chamber of the housing, a casing disposed in the lower portion of the housing and including at least one notch formed in an upper portion of the casing, a first lock member attached to the lower portion of the housing and engaged with the casing for retaining the casing in the housing and for attaching to a mounting structure, a base member disposed in the chamber of the housing and engaged with the casing and including at least one key extended downwardly therefrom and engaged with the notch of the casing for anchoring the base member to the casing and for preventing the base member from being rotated relative to the casing, and including at least one port for receiving a water, and a water control device including a water guide member and a water control valve disposed in the upper portion of the chamber of the housing and engaged with the base member, and the water control valve including a stem extended upwardly therefrom for engaging with a hand grip which controls and rotates the water control valve relative to the water guide member and the base member to control the water to flow out through the spout of the housing.

The chamber and the housing include a cylindrical structure having a uniform inner diameter and outer diameter for easily assembling the base member and the water control device. The housing includes an inner thread formed in the lower portion of the housing, and the first lock member includes an outer thread for threading with the inner thread of the housing.

A second lock member is further be provided and attached to the upper portion of the housing and engaged with the water control valve for retaining the water guide member and the water control valve and the base member in the housing. The housing includes an inner thread formed in the upper portion of the housing, and the second lock member is threaded with the inner thread of the housing.

The casing includes at least one coupling member provided in the casing, an anchoring member is further provided, and at least one fastener is engaged through the anchoring member and engaged with the coupling member of the casing for securing the casing and the housing to the mounting structure.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a faucet attachment device in accordance with the present invention;

FIG. 2 is a partial cross sectional view of the faucet attachment device taken along lines 2-2 of FIG. 1 illustrating the attachment of the faucet attachment device onto the basin, sink, or other mounting structure;

FIG. 3 is a partial exploded view of the faucet attachment device; and

FIG. 4 is a bottom perspective view illustrating a base member of the faucet attachment device.

### DETAILED DESCRIPTION OF THE PREFERRED EMBODIMENT

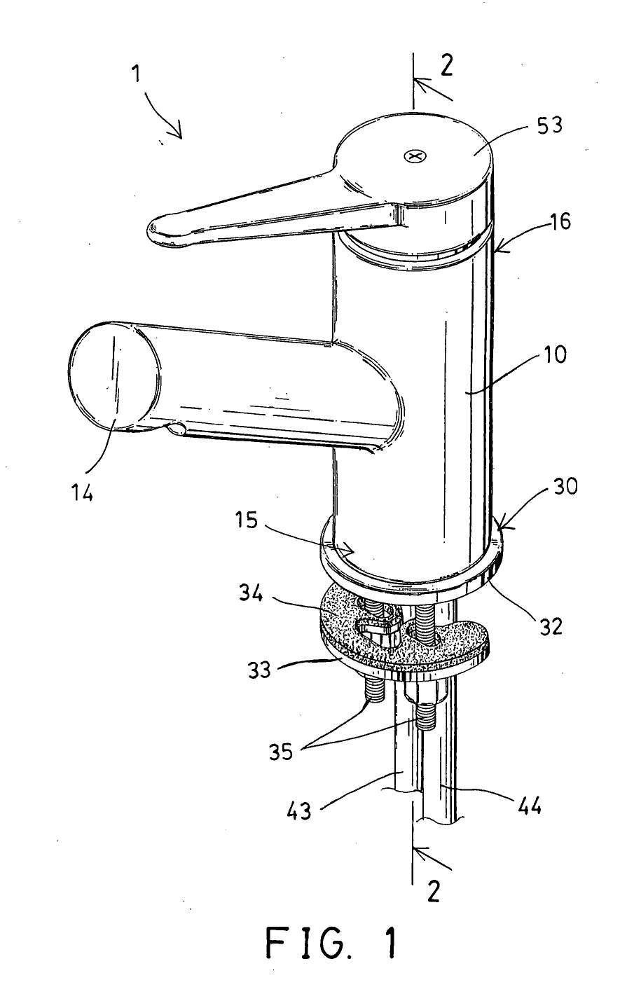

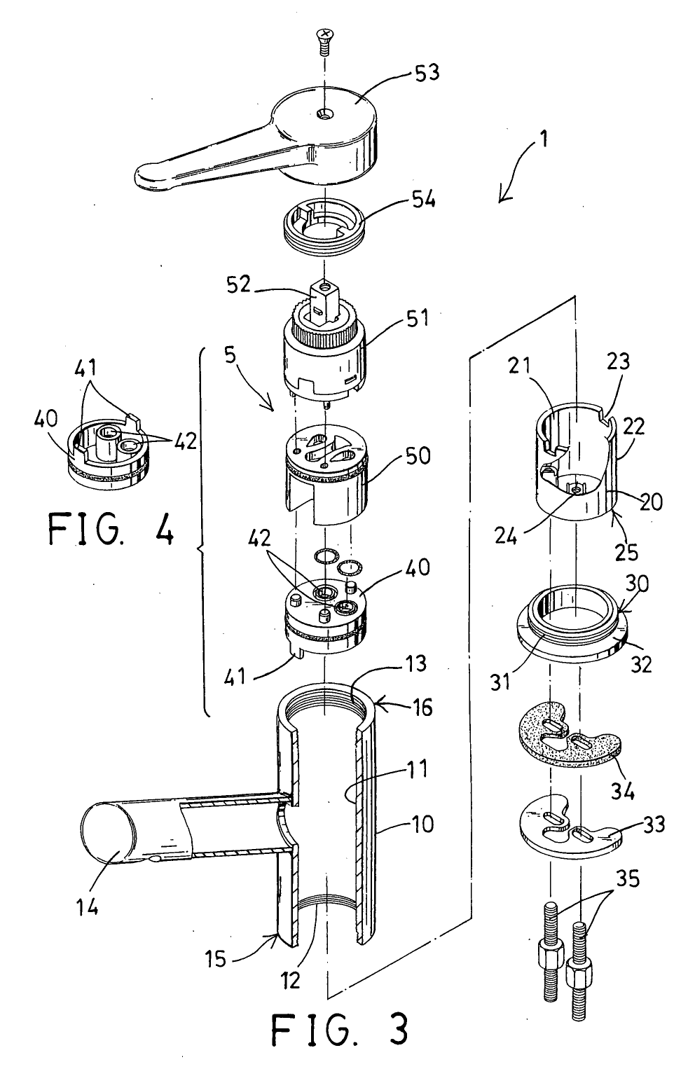

Referring to the drawings, and initially to FIGS. 1-3, a faucet attachment device 1 in accordance with the present invention comprises an outer housing 10 including a chamber 11 formed therein, and including an inner thread 12 formed in the lower portion 15 thereof, and including another inner thread 13 formed in the upper portion 16 thereof, and including a spout 14 extended outwardly from the middle or upper portion of the housing 10 and communicating with the chamber 11 of the housing 10 for guiding or directing the water to selectively flow out through the spout 14 of the housing 10. The chamber 11 and the housing 10 include a cylindrical structure having a uniform inner diameter and outer diameter.

A casing 20 is disposed within the lower portion 15 of the chamber 11 of the housing 10, and includes a compartment 21 formed therein, and formed or defined by an outer peripheral wall 22, and includes one or more (such as two) notches 23 formed in the upper portion of the outer peripheral wall 22, and includes one or more (such as two) screw holes or coupling members 24 formed or provided in the lower portion of the casing 20. It is preferable that the casing 20 includes an outer diameter equals to or slightly smaller than the inner diameter of the housing 10 for allowing the casing 20 to be snugly fitted within the chamber 11 of the housing 10.

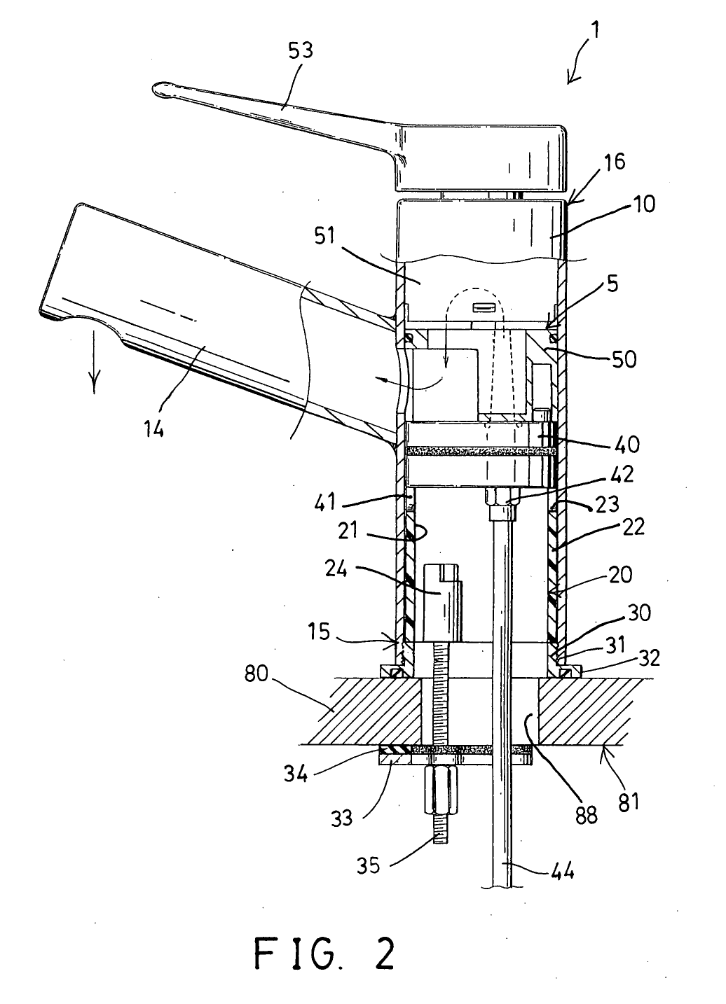

A ring member or lock member 30 includes an outer thread 31 for threading or engaging with the inner thread 12 of the housing 10 and for detachably attaching or securing the lock member 30 to the lower portion 15 of the housing 10, the lock member 30 is contacted or engaged with the casing 20 (FIG. 2) for stably retaining or supporting the casing 20 in the housing 10, and includes a peripheral flange 32 extended radially and outwardly from the lock member 30 for engaging with the housing 10 and for anchoring the casing 20 to the housing 10, and for limiting the casing 20 to slide relative to the housing 10, and also for preventing the casing 20 from being completely engaged into the housing 10.

In assembling or attaching the faucet attachment device 1 to a basin, sink top, or other mounting structure 80 which includes an opening 88 formed therein, as shown in FIG. 2, the housing 10 and/or the lock member 30 are contacted or engaged with or onto the mounting structure 80 and disposed above the opening 88 of the mounting structure 80, a washer or anchoring member 33 and/or a gasket or pad 34 are attached or engaged onto the bottom portion 81 of the mounting structure 80, and one or more (such as two) fasteners 35 are engaged through the anchoring member 33 and/or the pad 35 and threaded or engaged with the coupling members 24 of the casing 20 for easily and readily and solidly attaching or securing the housing 10 of the faucet attachment device 1 to the mounting structure 80.

A base member 40 is also disposed within the chamber 11 of the housing 10, and contacted or engaged with the upper portion of the casing 20 (FIG. 2), and includes one or more (such as two) keys 41 extended downwardly therefrom and engaged with the notches 23 of the casing 20 for anchoring the base member 40 to the casing 20 and for preventing the base member 40 from being rotated relative to the casing 20, and includes one or more (such as two) ports 42 (FIGS. 2, 4) for coupling to a cold water reservoir and a hot water reservoir (not shown) with pipes 43, 44 respectively and for receiving the cold water and the hot water from the water reservoirs respectively.

A water control means or device 5 includes a water guide member 50 and a water control valve 51 disposed within the upper portion 16 of the chamber 11 of the housing 10, and contacted or engaged with the upper portion of the base member 40, and the water control valve 51 includes a stem 52 extended upwardly therefrom for engaging with a handle or hand grip 53 which may control or rotate the water control valve 51 relative to the water guide member 50 and/or the base member 40, and for controlling the mixing of the cold water and the hot water and for controlling the mixed water to selectively flow out through the spout 14 of the housing 10. Another ring member or lock member 54 is threaded or engaged with the inner thread 13 of the housing 10 or attached to the upper portion 16 of the housing 10 and contacted or engaged with the upper portion of the water control valve 51 for stably retaining or anchoring the water guide member 50 and the water control valve 51 and the base member 40 in the housing 10.

It is to be noted that the structure of the water guide member 50 and the water control valve 51 is typical and is not related to the present invention and will not be described in further details. Two examples of the water guide member 50 and the water control valve 51 have been disclosed in U.S. Pat. No. 5,727,587 to Yang, and U.S. Pat. No. 6,029,687 to Chang which may be taken as the reference for the present invention. The above-described structure or the typical water guide devices and the typical water control valves may be easily and readily attached or secured or engaged into the chamber 11 of the housing 10 and solidly retained in the housing 10 with the lock members 30, 54.

In operation, as shown in FIGS. 1 and 2, the casing 20 and the base member 40 and the water guide member 50 and the water control valve 51 may be easily and readily attached or secured or engaged into the chamber 11 of the housing 10 and solidly retained in the housing 10 with the lock members 30, 54. The housing 10 may then be engaged onto the mounting structure 80 and disposed above the opening 88 of the mounting structure 80, the anchoring member 33 and the pad 35 may then be attached or engaged onto the bottom portion 81 of the mounting structure 80, and the fasteners 35 may then be engaged through the anchoring member 33 and/or the pad 35 and threaded or engaged with the coupling members 24 of the casing 20 for easily and readily and solidly attaching or securing the housing 10 of the faucet attachment device 1 to the mounting structure 80.

Accordingly, the faucet attachment device in accordance with the present invention includes an improved structure for easily and readily attaching or securing the faucet to the basin, sink, or other mounting structure.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A faucet attachment device comprising:
a housing including a chamber formed therein, and including a lower portion and an upper portion, and including a spout extended out from said housing and communicating with said chamber of said housing,
a casing disposed in said lower portion of said housing and including at least one notch formed in an upper portion of said casing,
a first lock member attached to said lower portion of said housing and engaged with said casing for retaining said casing in said housing and for attaching to a mounting structure,
a base member disposed in said chamber of said housing and engaged with said casing and including at least one key extended downwardly therefrom and engaged with said at least one notch of said casing for anchoring said base member to said casing and for preventing said base member from being rotated relative to said casing, and including at least one port for receiving a water, and
a water control device including a water guide member and a water control valve disposed in said upper portion of said chamber of said housing and engaged with said base member, and said water control valve including a stem extended upwardly therefrom for engaging with a hand grip which controls and rotates said water control valve relative to said water guide member and said base member to control the water to flow out through said spout of said housing.

2. The faucet attachment device as claimed in claim 1, wherein said chamber and the housing include a cylindrical structure having a uniform inner diameter and outer diameter.

3. The faucet attachment device as claimed in claim 1, wherein a second lock member is attached to said upper portion of said housing and engaged with said water control valve for retaining said water guide member and said water control valve and said base member in said housing.

4. The faucet attachment device as claimed in claim 3, wherein said housing includes an inner thread formed in said upper portion of said housing, and said second lock member is threaded with said inner thread of said housing.

5. The faucet attachment device as claimed in claim 1, wherein said casing includes at least one coupling member provided in said casing, an anchoring member, and at least one fastener engaged through said anchoring member and engaged with said at least one coupling member of said casing for securing said casing and said housing to the mounting structure.

6. The faucet attachment device as claimed in claim 1, wherein said housing includes an inner thread formed in said lower portion of said housing, and said first lock member includes an outer thread for threading with said inner thread of said housing.
